(19) United States
(12) Patent Application Publication
(10) Pub. No.: US 2006/0287905 A1
(43) Pub. Date: Dec. 21, 2006

(54) Calendar folders

(75) Inventor: Chris Stoner, Westford, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/153,975

(22) Filed: Jun. 16, 2005

(51) Int. Cl. G06F 15/02

(52) U.S. Cl. 705/9

(57) ABSTRACT

Embodiments of the present invention address deficiencies of the art in respect to calendaring and scheduling and provide a method, system and computer program product for providing calendar folders configured to facilitate access to a sub-set of scheduled events and associated content. In one embodiment, a calendaring and scheduling (C&S) data processing system can include a C&S system providing a calendar view for viewing scheduled events and a calendar folder data store configured to store one or more different calendar folders. Each of the different calendar folders can store differently categorized calendared events. Finally, the system can include calendar folder processing logic enabled to manage storage and retrieval of calendar events to the different calendar folders in the calendar folder data store.

### BACKGROUND OF THE INVENTION

1. Field of the Invention

The present invention relates to the field of calendaring and scheduling systems and more particularly to the field of storing meeting information in a calendaring and scheduling system.

2. Description of the Related Art

Calendaring systems have formed the core component of personal information management software and firmware applications for decades. Initially, a mere calendar display, modern calendaring systems provide scheduling and alarm functions in addition to full integration with contact management, time entry, billing and project management applications. The typical calendaring application minimally provides a mechanism for scheduling an event to occur on a certain date at a certain time. Generally, the event can be associated with a textual description of the event. More advanced implementations also permit the association of the scheduled event with a particular contact, a particular project, or both. Furthermore, most calendar applications provide functionality for setting an alarm prior to the occurrence of the event, as well as archival features.

Several software products include support for Calendaring & Scheduling (C&S). Known C&S products include Lotus™ Notes™, Microsoft™ Outlook™, and web-based products like Yahoo™ Calendar™. These products allow one to manage personal events including appointments and anniversaries. C&S products also typically allow one to manage shared events, referred to generally as meetings. Electronic Calendaring and Scheduling software allows a group of people to negotiate around the scheduling of a proposed event such as a meeting, with the goal of selecting a time that allows most of the group to attend.

Oftentimes, heavy C&S users can schedule so many meetings cannot readily locate a particular meeting of interest in a calendar interface. Specifically, meetings of interest can become lost in a sea of meetings so that important meetings cannot be readily identified among the noise. In the context of task management, C&S users have grown accustomed to categorizing and filing tasks to better identify tasks of interest. Meetings differ from tasks, however, in that meetings are closely linked to participants, times and locations. Thus, the preferred view for a meeting is not a list as in the case of a task, but in a calendar. Also, whereas tasks generally are standalone elements, meetings often involve ancillary documents and even tasks.

In this regard, to adequately prepare for a meeting, it can be important to have access to all related materials ancillary to the meeting. Moreover, to adequately reflect upon the occurrence of a meeting, it can be important to have access to all related materials produced in consequence of the meeting. Yet, present solutions merely offer advanced searching facilities able to produce a filtered subset of documents and tasks related to a scheduled meeting. Examples, include that which is disclosed in W. J. Johnson et al, Automatic Preparation of Documents in Calendar Event Order, IBM Technial Disclosure Bulletin, Vol. 37, No. 3 (March 1994) and in U.S. Pat. No. 5,842,009 to Borovoy et al. for SYSTEM FOR AUTOMATICALLY RETRIEVING INFORMATION RELEVANT TO A USER'S SCHEDULED EVENT. Additionally, it is well known to provide a user-selected sub-set of meetings for display in a filtered calendar such as in U.S. Pat. No. 6,369,840 to Barnett et al. for MULTI-LAYERED ONLINE CALENDARING AND PURCHASING.

### BRIEF SUMMARY OF THE INVENTION

Embodiments of the present invention address deficiencies of the art in respect to calendaring and scheduling and provide a novel and non-obvious method, system and computer program product for providing calendar folders configured to facilitate access to a sub-set of scheduled events and associated content. In one embodiment, a C&S data processing system can include a C&S system providing a calendar view for viewing scheduled events and a calendar folder data store configured to store one or more different calendar folders. Each of the different calendar folders can store differently categorized calendared events. Finally, the system can include calendar folder processing logic enabled to manage storage and retrieval of calendar events to the different calendar folders in the calendar folder data store.

In another embodiment, a method for managing calendar folders for calendar events in a C&S system can include scheduling an event in the C&S system, assigning a categorization to a calendar folder in the C&S system, and storing the event in a calendar folder having a categorization consistent with a categorization for the event. Optionally, the method further can include receiving workflow content associated with the event and storing the workflow content in the calendar folder. The method yet further can include assigning further categorizations to other calendar folders in the C&S system. Finally, the method can include rendering in a calendar view for the C&S system, an activatable user interface element associated with the calendar folders, detecting an activation of the user interface element, and displaying the calendar folders in the calendar view in response to detecting the activation.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustrating of a C&S system configured for managing calendar folders for calendar events and related content;

FIG. 2 is a pictorial illustration of a C&S user interface enabled for calendar folders in the system of FIG. 1; and,

FIG. 3 is a flow chart illustrating a process for managing content related to calendared events in the calendar folders of FIG. 1.

### DETAILED DESCRIPTION OF THE INVENTION

Embodiments of the present invention provide a method, system and computer program product for calendar folder management in a C&S system. In accordance with an embodiment of the present invention, one or more calendar folders can be established in fixed storage for storing scheduled events in the C&S system. For instance, different ones of the calendar folders can be associated with different categories for the scheduled events. Notably, content associated with particular calendar events further can be stored in the calendar folders corresponding to the particular calendar events. In this way, access can be provided to all related materials ancillary to a scheduled event.

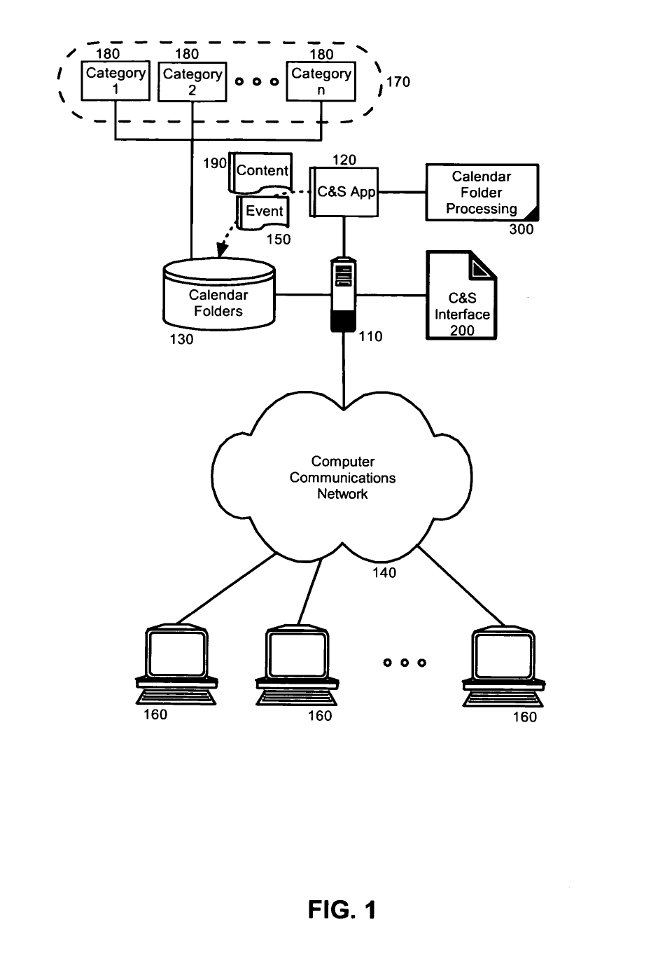

In illustration of a particular arrangement consistent with the present invention, FIG. 1 is a schematic illustrating of a C&S system configured for managing calendar folders for calendar events and related content. As shown in FIG. 1, the system can include a computing platform 110 configured for communicative coupling to one or more other computing platforms 160 over a computer communications network 140. The computing platform 110 can include a C&S application 120 programmed to calendar, schedule or otherwise establish events 150 such as meetings, appointments, phone calls and the like.

The C&S application 120 can include a user interface 200 providing an end user view of a calendar having one or more scheduled events 150. The user interface 200 further can include access to data store of calendar folders 130. The data store calendar folders 130 can include a storage hierarchy of folders 180, for example where each has an association with a different category for the events 150. In this regard, the different folders 180 can store different events 150 associated with the different categories. Consequently, one seeking to view only those of the events 150 which have been stored in association a particular one of the categories can open a corresponding one of the calendar folders 180 for the particular one of the categories.

Notably, calendar folder processing logic 300 can be coupled to the C&S application 120. The calendar folder processing logic 300 can include code for managing the storage and retrieval of events 150 to and from folders 180 in the data store of calendar folders 130. Additionally, the calendar folder processing logic 300 can include code to manage the storage and retrieval of content 190 to and from folders 180 in the data store of the calendar folders 130. In this regard, as content 190, including workflow items such as tasks, call, notes and documents are generated in association with scheduled ones of the events 150 already assigned to particular ones of the folders 180, the content 190 also can be stored in the same ones of the folders 180 in the data store of calendar folders 130. Consequently, access can be provided to all related materials ancillary to a scheduled one of the events 150.

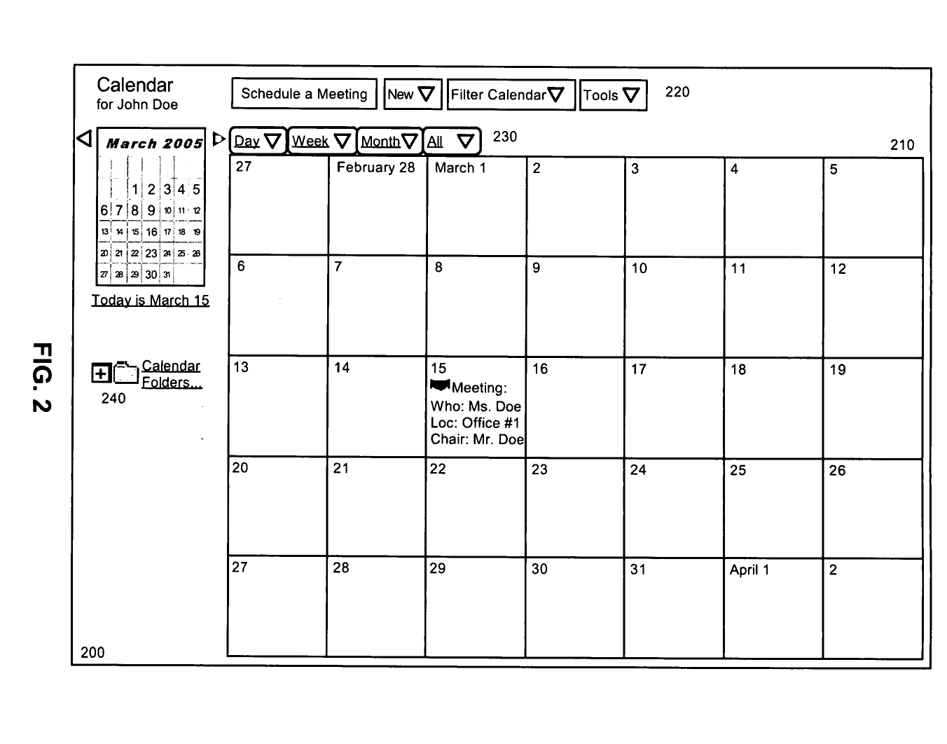

In more particular illustration of the user interface 200 of the C&S system of FIG. 1, FIG. 2 is a pictorial illustration of a C&S user interface 200 enabled for calendar folders. The C&S user interface 200 can include a calendar view 210 of a set of scheduled events for one or more end users. The calendar view 210 can be a comprehensive view, or the calendar view 210 can provided a filtered view of calendared events according to different selection parameters. The calendar view 210 yet further can include a tool bar 220 for manipulating events viewed through the calendar view 210, as well the calendar view 210 can include different tabbed viewed 230 establishing different date ranges for viewing.

Notably, an activatable calendar folders user interface element 240 can be provided. The activatable calendar folders user interface element 240 can provide access to a file view of different calendar folders containing different events. Each calendar folder can be associated with a particular category for contained events. Moreover, workflow content corresponding to already stored events can be stored in a corresponding one of the calendar folders. In this way, an end user activating the activatable calendar folders user interface element 240 can view all related materials ancillary to a scheduled one of the events associated with a selected one of the calendar folders.

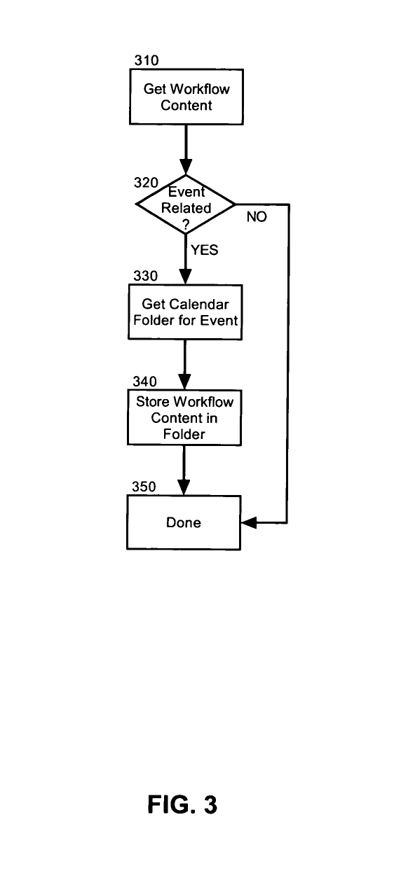

In yet further illustration, FIG. 3 is a flow chart illustrating a process for managing content related to calendared events in the calendar folders of FIG. 1. Beginning in block 310, workflow content can be received for processing. The workflow content can include tasks, documents or notes, to name a few. In some cases, the workflow content can relate to a scheduled event in the C&S system. Thus, in decision block 320, it can be determined whether the workflow content relates to a scheduled event which has been stored in a calendar folder. If so, in block 330 the calendar folder for the scheduled event can be identified and in block 340 the workflow content can be stored in the identified folder. Finally, the process can end in block 350.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A calendaring and scheduling (C&S) data processing system comprising:
a C&S system providing a calendar view for viewing scheduled events;
a calendar folder data store configured to store a plurality of different calendar folders, each of said different calendar folders storing differently categorized calendared events; and,
calendar folder processing logic enabled to manage storage and retrieval of calendar events to said different calendar folders in said calendar folder data store.

2. The C&S data processing system of claim 1, wherein said different calendar folders further store workflow content associated with said differently categorized calendared events.

3. The C&S data processing system of claim 2, wherein said workflow content comprises content selected from the group consisting of tasks, to-dos, phone calls, notes and documents.

4. The C&S data processing system of claim 1, wherein said C&S system is configured for client-server access to said scheduled events.

5. The C&S data processing system of claim 1, wherein said calendar view comprises an activatable calendar folders user interface element configured to respond to an activation event by causing a rendering of a view of said different calendar folders.

6. A method for managing calendar folders for calendar events in a calendaring and scheduling (C&S) system, the method comprising:
scheduling an event in the C&S system;
assigning a categorization to a calendar folder in the C&S system; and,
storing said event in a calendar folder having a categorization consistent with a categorization for said event.

7. The method of claim 6, further comprising:
receiving workflow content associated with said event; and,
storing said workflow content in said calendar folder.

8. The method of claim 6, further comprising assigning further categorizations to other calendar folders in the C&S system.

9. The method of claim 8, further comprising:
rendering in a calendar view for said C&S system, an activatable user interface element associated with said calendar folders;
detecting an activation of said user interface element; and,
displaying said calendar folders in said calendar view in response to detecting said activation.

10. A computer program product comprising a computer usable medium having computer usable program code for managing calendar folders for calendar events in a calendaring and scheduling (C&S) system, said computer program product including:
computer usable program code for scheduling an event in the C&S system;
computer usable program code for assigning a categorization to a calendar folder in the C&S system; and,
computer usable program code for storing said event in a calendar folder having a categorization consistent with a categorization for said event.

11. The computer program product of claim 10, further comprising:
computer usable program code for receiving workflow content associated with said event; and,
computer usable program code for storing said workflow content in said calendar folder.

12. The computer program product of claim 10, further comprising computer usable program code for assigning further categorizations to other calendar folders in the C&S system.

13. The computer program product of claim 12, further comprising:
computer usable program code for rendering in a calendar view for said C&S system, an activatable user interface element associated with said calendar folders;
computer usable program code for detecting an activation of said user interface element; and,
computer usable program code for displaying said calendar folders in said calendar view in response to detecting said activation.
